(19) United States
(12) Patent Application Publication
(10) Pub. No.: US 2026/0099695 A1
(43) Pub. Date: Apr. 9, 2026

(54) PYRAMID KEY-VALUE CACHE COMPRESSION FOR TRANSFORMER MODELS

(71) Applicant: Microsoft Technology Licensing, LLC, Redmond, WA (US)

(72) Inventors: Wen XIAO, Vancouver (CA); Wei XIONG, Bellevue, WA (US); Abedelkader ASI, Sammamish, WA (US); Zefan CAI, Madison, WI (US)

(21) Appl. No.: 18/910,974

(22) Filed: Oct. 9, 2024

(51) Int. Cl. G06N 3/045

(52) U.S. Cl. CPC G06N 3/045

(57) ABSTRACT

A method for operating a transformer model includes algorithmically allocating a fixed budget for a key-value cache between multiple decoding layers per an allocation scheme that ensures progressively higher decoding layers in the transformer model are allocated progressively smaller quantities of cache memory. The method further includes configuring each of the multiple decoding layers of the transformer model to retain no more than a maximum number of key-value vector pairs in the key-value cache during a token decoding operation, the maximum number of key-value vector pairs being independently determined for each decoding layer of the multiple decoding layers based on the cache memory that is allocated to the decoding layer.

### BACKGROUND

Decoder-only transformer models generate data step-by-step, predicting the next element in a sequence based on previously processed elements in the same sequence. In the context of large language models (LLMs), this means predicting the next word or token based on the preceding words in the sentence. Some existing decoder-only transformer models have been scaled to handle contexts as high as 128 k token of input and output combined. However, scaling these models to process these long text sequences leads to significant processing latencies that arise primarily due to the computation of a mechanism known as “attention” within each layer of the model.

Attention is a machine learning method for determining relative importance of each element in a sequence relative to other components in that sequence. Attention entails computing set of “soft” weights that indicate how much focus or importance an input token (e.g., a word) should receive from other tokens of the same input prompt. The goal is to calculate these weights so that the model can assign higher values to more relevant tokens or to tokens that have stronger relationships with the current token being processed.

In a decoder-only transformer model, attention is computed within each decoding layer. In some models, each decoding layer has multiple attention heads that have been trained with different weights to focus on different parts of the input sequence. Computing attention for each sequential token in an input prompt entails a set of mathematical computations that utilize two matrices, known as the key matrix and the value matrix. These matrices are appended to include additional data each time a new token is processed and, therefore, grow in size as more and more tokens in the input prompt are sequentially processed by the same attention head. Repeatedly computing the values of the key and value matrices can lead to significant processing delays, particularly during the processing of long input and output sequences. A common solution to mitigate these delays involves caching key and value states of already-processed tokens. The cache storing these states is commonly referred to as a “KV Cache.” However, KV caching leads to extensive graphics processing unit (GPU) consumption. For instance, maintaining a KV cache for 100 k tokens in LLaMA-2 requires over 50 GB of memory, while a 2K context requires less than 1 GB of memory.

### SUMMARY

According to one implementation, a cache allocation scheme provides for algorithmically allocating a fixed budget for a key-value cache between multiple decoding layers of a transformer model in a manner that ensures progressively higher decoding layers in the transformer model are allocated progressively smaller quantities of cache memory. The method further includes configuring each of the multiple decoding layers of the transformer model to retain no more than a maximum number of key-value vector pairs in the key-value cache during a decoding operation, the maximum number of key-value vector pairs being independently determined for each decoding layer of the multiple decoding layers based on the cache memory that is allocated to the decoding layer.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example system that algorithmically allocates memory of a key-value (KV) cache to different decoding layers in a transformer model according to a pyramid allocation scheme.

FIG. 2 illustrates example operations performed within a decoding layer of a transformer model to compute self-attention using key-value vector pairs stored in a key-value cache.

FIG. 3 illustrates example operations performed by a self-attention block within a decoding layer of a transformer model implementing a herein-disclosed key-value cache compression strategy.

FIG. 4 illustrates a plot that illustrates selective caching of various key-value vector pairs according to the herein-disclosed KV cache compression methodology.

FIG. 5 illustrates example operations for utilizing the herein-disclosed KV cache compression scheme.

FIG. 6 illustrates an example schematic of a processing device suitable for implementing aspects of the disclosed technology.

### DETAILED DESCRIPTION

The herein-disclosed technology includes a caching strategy and cache memory allocation methodology, collectively referred to herein as “KV cache compression,” that facilitates a reduction in the quantity of cache memory utilized by decoder-only transformer models. This reduction in cache memory utilization is realized without a significant reduction in model performance.

According to one implementation, the disclosed caching allocation methodology allocates a fixed total KV cache memory budget statically among different layers of a transformer model so that progressively-higher decoding layers within the model are allocated decreasing quantities of the cache memory budget. For example, each decoding layer is allocated a smaller portion of the cache memory budget than the decoding layer directly below it. As a result, the overall KV cache size can be visualized as having a pyramid shape. As used herein, a model layer is said to be “lower” when the layer is physically is closer to the initial input to the layer stack and “higher” when the layer closer to the overall output of the layer stack. Notably, implementations may exist where the key-value cache takes on an overall pyramid shape but also includes two or more consecutive decoding layers with identical cache memory allocations.

To ensure this non-conventional memory allocation does not substantially degrade model performance, the pyramid-shaped KV cache allocation is paired with a caching strategy that utilizes localized attention computations to predict, at each model layer, which tokens in the input sequence are the most “important” in the interpretation of the sequence as whole. The key-value vectors for these identified important tokens are then cached (in lieu of key-value vectors for all previously-computed tokens), and it is these important tokens that are used to compute the attention information that is forwarded onto the next model layer. Due to the reduced cache budget allocated to each progressively higher level in the pyramid memory allocation, each layer decoding layer in the model is permitted to select fewer important tokens to cache and use in the attention computations than the decoding layer directly below it.

The above-described caching strategy works (e.g., does not degrade model performance) in part because this strategy leverages the inherent tendency of transformer models to aggregate and localize attention information that is learned over time. At lower layers, the transformer model identifies a lot of input words as being potentially important; however, at higher levels (further and further from the input), the attention information is increasingly aggregated, which causes the model to focus its attention on a few key tokens. Because the herein-disclosed caching methodology provides for dropping more and more key-value pairs from the cache at increasingly higher levels of the model—e.g., as the model's understanding of attention improves at each increasingly higher layer, it is possible to substantially reduce total cache size without discarding the important attention information that the model needs to ensure prediction accuracy.

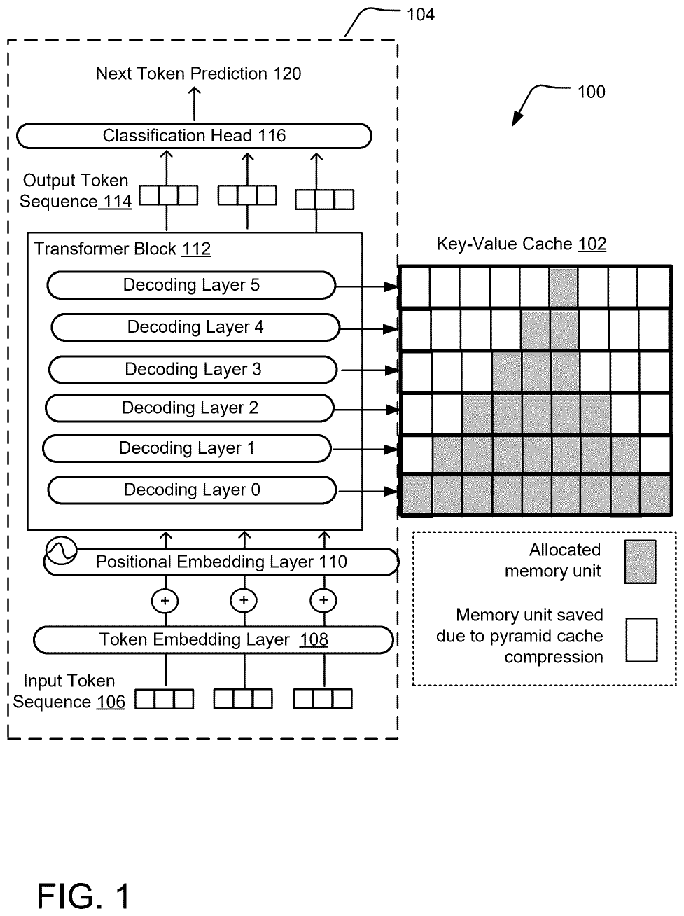

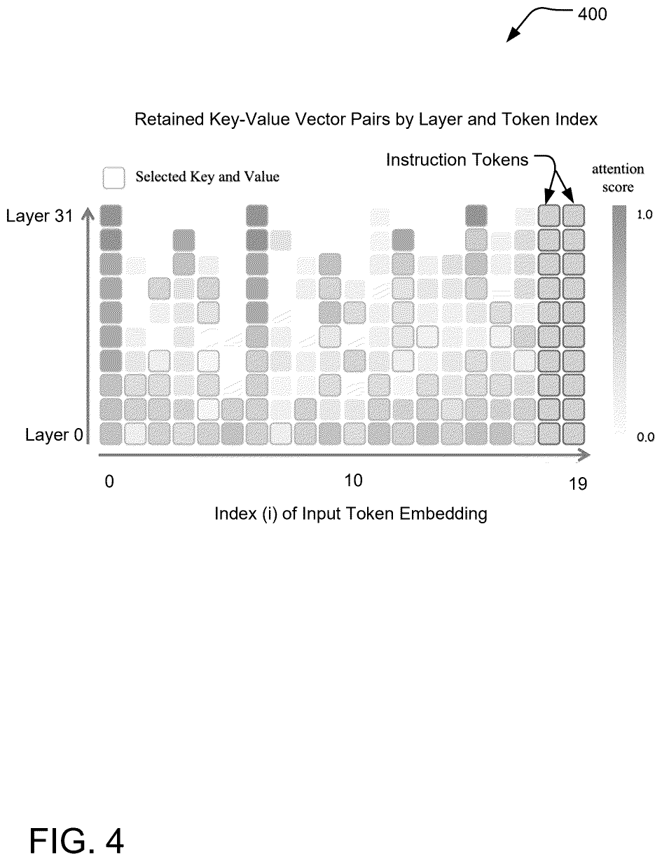

FIG. 1 illustrates an example system 100 that utilizes a static pyramid allocation scheme to algorithmically allocate memory of a key-value cache 102 to different decoding layers in a transformer model 104. The transformer model 104 provides an architecture that is commonly used for tasks like text generation, language processing, and other sequence prediction tasks. Although the following description presents a number of data processing examples that pertain specifically to processing of natural language inputs, the herein-disclosed pyramid cache allocation scheme and caching strategy are contemplated for use in any type of sequential processing model including, for example, multimodal models that can receive prompts that include various types of input (e.g., text, image, audio, and/or video data) and likewise generate outputs of various types that are not necessarily the same as the input type. In FIG. 4, the transformer model 104 is shown to be a decoder-only transformer model 104. However, the disclosed technology is contemplated for implementation in any transformer model with multiple decoding layers.

The transformer model 104 is shown to include a token embedding layer 108 that converts vectors of an input token sequence (e.g., vectors representing words, sub-words, or characters) into dense vectors defined within a higher-dimensional vector space in which similar tokens have similar embeddings. The embeddings generated by the token embedding layer 108 are then passed to a positional embedding layer 110 that adds information about the position of each token in the sequence to the embeddings.

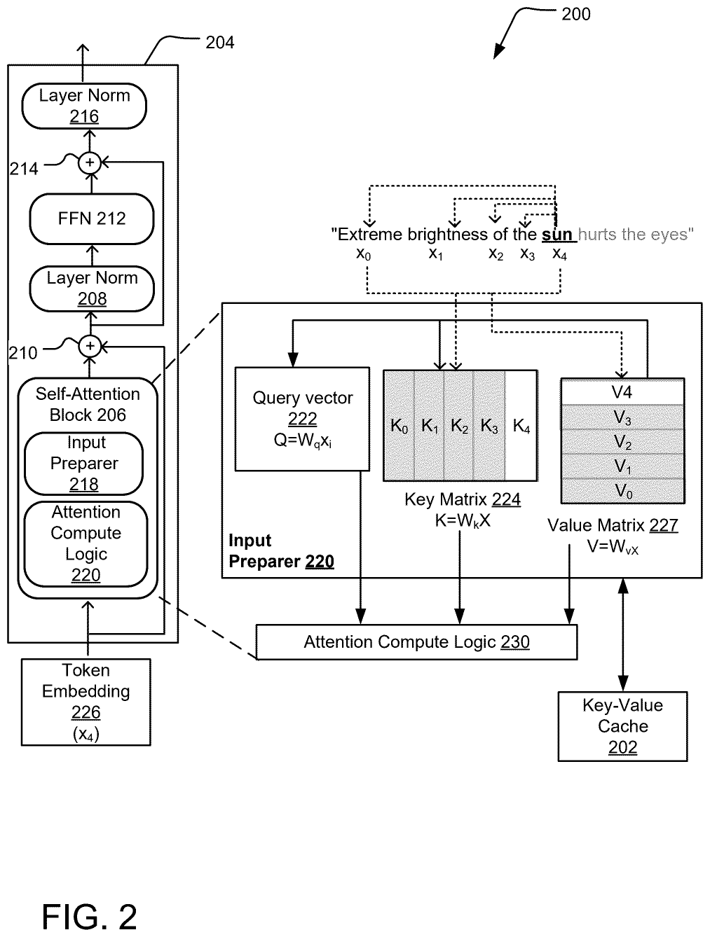

The embeddings output by the positional embedding layer 110 are input to a transformer block 112 that includes a number of decoding layers. In the example of FIG. 1, the transformer block 112 is shown to include six decoding layers, numbered 0-5. However, in other implementations, the transformer block 112 includes a fewer or greater number of decoding layers. Each of the decoding layers (e.g., numbered 0-5) includes a masked, self-attention mechanism-referred to herein as a “self-attention block,” which may include either a single attention head or multiple attention heads. Each decoding layer also typically includes a feedforward neural network (FFN). Within each decoding layer, the self-attention block and FFN may be wrapped with various residual connections and layer normalization layers. A more detailed view of an example decoder layer is shown and discussed with respect to FIG. 2.

The transformer block 112 generates an output token sequence 114, which typically include a same number of vectors (tokens) as the input token sequence 106. The output token vectors are then provided to a classification head 116 that performs a linear projection of the output vectors and applies a SoftMax function to each linearly-projected vector. This converts each token into a probability distribution over the vocabulary of the model, and the probability distributions are used to generate a next token prediction 120.

In the system 100, each decoding layer in the transformer block 112 is allocated a set quantity of memory in the key-value cache 102. This cache memory is used to store key and value vectors (discussed further with respect to FIG. 2) used when computing attention for each sequentially processed token in the input token sequence 106. In FIG. 1, the key-value cache 102 is represented as a grid of rectangles that each represents an equal quantity of GPU memory. Some of the rectangles (memory units) are shaded to help illustrate how memory is allocated in the system 100. Unshaded rectangles within the key-value cache 102 collectively represent cache memory savings that is realized within the system 100 as compared to other traditional systems that allocate an equal cache memory budget to each decoding layer. These unshaded rectangles represent memory that is excluded entirely from the key-value cache 102 and are shown primarily for referential comparison with these other existing systems.

In the system 100, the total cache memory budget of the key-value cache 102 is allocated among the different decoding layers (0-5) in an uneven fashion, with progressively higher layers of the transformer block 112 generally being allocated smaller and smaller quantities of the memory from the key-value cache 102. For example, each decoding layer allocates less cache memory than the decoding layer immediately below it. The result is a “pyramid-shaped” allocation, as is generally illustrated by the collective shape of the stacked, shaded rectangles in the key-value cache 102. Notably, there are many different types of pyramid shapes—e.g., walls of different slopes and peaks that may be either sharp and pointy or broad and rounded-all of which may correspond to different memory allocations suitable for implementing the disclosed technology.

In one implementation, the key-value cache 102 is of fixed size throughout ongoing nominal operations of the transformer model 104. This total fixed memory budget of the key-value cache 102 is arithmetically allocated among the layers of the decoding model per a formula that results in a layer-specific allocation that is generally pyramid-shaped, similar to that shown in FIG. 1. This layer-specific cache memory allocation also remains fixed throughout nominal operations of the transformer model 204. Although there may exist multiple suitable methodologies for implementing this allocation, one suitable methodology provides for allocating the bottom decoding layer (e.g., decoding layer 0) a portion of the total fixed memory budget that is given by equation 1 below:

$${k}^{0} = ( \frac{2 {k}^{total}}{m} ) \qquad ( 1 )$$

where k⁰ is the cache budget allocated to the first decoding layer (with index 0, m is the total number of decoding layers in the transformer model 104, and k^{total} is the total fixed size of the key-value cache 102. Per this methodology, the top decoding layer (e.g., decoding layer 5 in this example) is allocated a quantity of the total fixed budget that is given by equation 2, below:

$${k}^{m - 1} = \frac{{k}^{t o t a l}}{β \cdot m} \qquad ( 2 )$$

where β is a constant that defined how rounded or sharp the top of the pyramid will be and is tunable for each different model. That is, different values of β may yield better performance in some models than others. Each layer of index/between the bottom decoding layer and the top decoding layer is allocated a quantity of the fixed cache budget given by equation 3, below:

$${k}^{l} = {k}^{0} - \frac{{k}^{0} - {k}^{m - 1}}{m} \times l \qquad ( 3 )$$

The memory savings represented by the unshaded rectangles in the key-value cache 102 can be understood as corresponding to the degree by which the disclosed technology effectively “compresses” the key-value cache 102 as compared to alternative approaches that allocate equal cache memory budget to all layers of the transformer block 112. The coefficient of total compression, as well as the distribution of memory among different model layers (and shape of the allocation which is influenced by the constant β), may vary in different implementations depending upon parameters optimized for performance with respect to each different model and each different supporting hardware architecture.

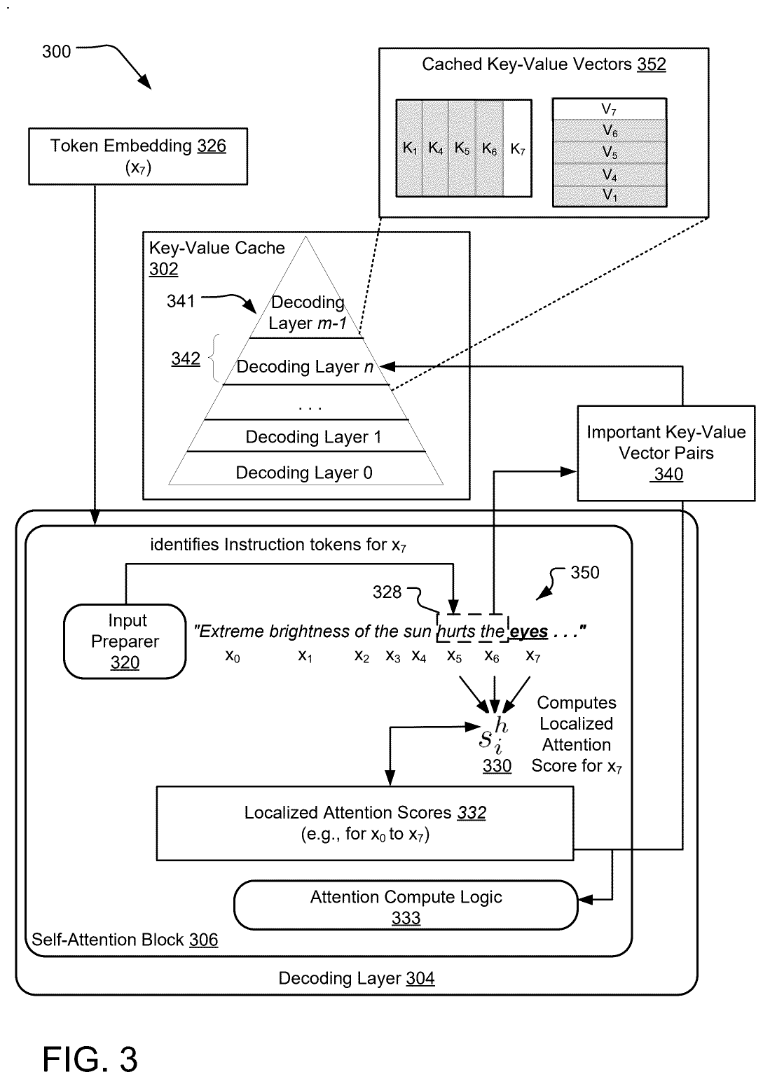

In one implementation, the illustrated pyramid-shape cache memory allocation scheme is paired with a caching strategy that is described in detail below with respect to FIG. 3. This caching strategy is a critical tool in implementing the pyramid-shaped cache memory allocation scheme without substantially degrading model performance. Although there is some trade-off between the coefficient of cache compression and model performance that varies depending upon the identity of the transformer model 104, simulations of the pyramid-shaped cache memory allocation paired with the herein-disclosed catching strategy demonstrate that model performance is substantially robust (unaffected) across a range of cache compression ratios. For instance, when the KV cache is reduced to 12% of full size, performance accuracy remains the same, and when the KV cache is reduced to less than 5% of full size, performance accuracy drops by 10% or less. Advantageously, the fixed, pyramid memory-allocation scheme can be implemented within any transformer model that uses a KV cache, regardless of scale.

FIG. 2 illustrates example operations 200 performed within a decoding layer 204 of a transformer model to compute attention for a token embedding 226 using key-value vector pairs stored in a key-value cache 202. The operations discussed below with respect to FIG. 2, are exemplary and intended to provide background context that helps illustrate what type of data is commonly stored within a key-value cache and how the key-value cache is routinely used.

The decoding layer 204 processes each token in an input sequence sequentially. In the example shown, the input sequence is “Extreme brightness of the sun hurts the eyes.” The decoding layer 204 sequentially receives input embeddings (e.g., a token embedding 226) corresponding to each token of the sequence. If the decoding layer 204 is not the lowest layer of the transformer block, then the received input embeddings are each a combination of the token embeddings processed by the previous layer. If, on the other hand, the decoding layer 204 is the lowest layer of the transformer block, the input embeddings are the initial token embeddings. For case of terminology, all embeddings input a decoding layer are referred to herein as “token embeddings.” The set of operations that the decoding layer 204 performs on each token embedding is referred to herein as a “token decoding operation.”

Within the decoding layer 204, each token embedding is first passed into the self-attention block 206, which computes attention for the token being currently processed. The self-attention block 206 performs attention operations, discussed in more detail below, that compute a weighted sum of all input token embeddings, with the weights being determined based on how relevant each token is to the token being currently processed. Each embedding output by the self-attention block 206 is passed through a residual connection 210 that adds the input of the self-attention block 206 to its output. This sum is then normalized by a normalization layer 208, and the normalized output is passed through a feed-forward neural network (FFN) 212, which usually consists of two linear (dense) layers with a non-linear activation function in between. The normalized sum output by the normalization layer 208 is passed through another residual connection 214 that adds the input of the FFN 212 to its output, followed by another layer normalization 216.

In FIG. 2, the self-attention block 206 is shown to include an input preparer 218 and attention compute logic 230. Notably, some attention blocks may be multi-headed, in which case each different attention head performs the operations discussed below with respect to the input preparer 218 and the attention compute logic 230.

The input preparer 218 typically consists of software that computes or retrieves (via a look-up in the key-value cache 202) a set of vectors used to compute attention for the token that is currently being processed. In FIG. 2, an example is shown wherein the self-attention block 206 is sequentially processing token embeddings corresponding to the token sequence “extreme brightness of the sun hurts the eyes.” At the time that is illustrated by FIG. 2, the self-attention block 206 is computing attention for the fifth token embedding in the input embedding sequence, a token embedding 226 (x₄). In this example, the token embedding 226 being processed corresponds to the word “sun.” It is assumed that the self-attention block 206 has already computed attention for token embeddings corresponding to “extreme,” “brightness,” “of,” and “the.”

To compute the attention for the token embedding 226 (“sun”), the input preparer determines three different matrices. The first matrix includes a single vector and is known as the “query vector 222,” or “Q” for short. This query vector 222, Q, is obtained by multiplying a learned weight (W_{q}) by the token embedding 226, which x₄ in the present example.

In addition to the query vector Q, the input preparer 220 also determines a key matrix 224, K, which includes a “key vector” corresponding to each token in the sequence that has been processed so far. Each vector Kᵢ in the key matrix 224, K, is initially computed by multiplying a token embedding of index (i) by another learned weight (Wₖ). In the example shown, the self-attention block 206 has previously processed the token embeddings corresponding to the words “extreme” (token index 0), “brightness” (token index 1), “of” (token index 2) and “the” (token index 3). Therefore, corresponding key values K₀-K₃ have previously been computed and stored in the key-value cache 202. The input preparer 220 retrieves a cached key matrix consisting of these key vectors, computes a new key vector, K₄, for the token embedding 226 (x₄, corresponding to “sun”) and appends the retrieved key matrix with the new key vector, yielding the key matrix 224 that is shown in FIG. 2. This key matrix 224 is used in the computation of attention for the token embedding 226 (x₄) that is currently being processed.

In addition to determining the key matrix 224, the input preparer 220 also determines a value matrix 227 using a similar methodology. Like the key matrix 224, the value matrix 227 includes a “value vector” corresponding to each input embedding in the sequence that has been processed so far. Each vector Vᵢ in the value matrix 227, V, is initially computed by multiplying an input embedding of corresponding index (i) by another learned weight (Wᵥ). In the example shown, the value vectors V₀ through V₃ have previously been computed and stored in the key-value cache 202. Thus, to determine the value matrix 227 that is used to compute attention for the token embedding 226, the input preparer 220 retrieves V₀ through V₃ from the key-value cache 202, computes a new value vector, V₄, for the token embedding 226 (x₄, corresponding to “sun”) and appends the retrieved value matrix with the new value vector, yielding the value matrix 227 as shown.

The input preparer 220 saves the updated key matrix 224 and the updated value matrix 227 (now including K₄ and V₄, respectively) in the key-value cache 202 so they do not need to be computed during processing of subsequent token embeddings of the input sequence. Notably, the size of the cached key and value matrices grow as more and more input embeddings are processed. For sequences consisting of thousands of input tokens, the storage of these matrices for each layer of the model results in significant memory consumption (e.g., 100 k tokens in LLaMA-2 requires over 50 GB of memory).

Once the input preparer 220 has determined the query vector 222, the key matrix 224, and the value matrix 227, as described above, these matrices are passed as inputs to the attention compute logic 230, which computes the attention for the token embedding 226. This entails taking the dot product between the query vector 222 and the key matrix 224 to derive a matrix of scores that quantify how similar or relevant each already-processed token embedding is to the token currently being processed—e.g., the token embedding 226. These scores are then scaled down (by dividing by the square root of the number of key vectors in the key matrix) and passed through a SoftMax function which normalizes the scores, turning them into a probability distribution where higher scores get higher probabilities. This ensures that the attention weights sum up to 1. Within a multi-headed decoder layer, the above-described attention mechanism within each head is computed by equation 4, below:

$${A}^{h} = softmax ( \frac{{Q}^{h} {( {K}^{h} )}^{T}}{\sqrt{{d}_{k}}} \qquad ( 4 )$$

where h is the index of the attention head, Q^{h} and K^{h} are the Query and Key matrices obtained for the head h (e.g., per the methodology described above), and dk denotes the dimension of key vectors within the key matrix K.

After obtaining the attention weights for the token embedding 226 per the above-described methodology, the attention weights (A^{h}) are then used to calculate a weighted sum of the value vectors of all token embeddings processed so far. This weighted sum represents the new representation of the token embedding 226 (e.g., the word “sun”), incorporating information from all other words based on their importance scores. Each different attention head uses its respective attention weights (A^{h}) to compute this weighted sum, and then the results of different attention heads are then concatenated before being input to the layer normalization block 208.

Notably, the traditional caching strategy described above entails caching and using the key and value vectors for all previously-processed tokens to compute the attention for the token embedding 226. This results in massive memory consumption for longer sequences with thousands of input tokens. A herein-disclosed improved caching strategy improves upon the methodology illustrated in FIG. 2 by leveraging a compression technique in combination with the pyramid-shaped cache allocation described with respect to FIG. 1. This improved caching strategy and compression technique are discussed in detail with respect to FIG. 3, below.

FIG. 3 illustrates example operations performed by a self-attention block 306 within a decoding layer 304 of a transformer model 300 implementing a herein-disclosed key-value cache compression strategy. Key-value cache compression is a technique that facilitates a reduction in the size of the key and value matrices stored within a key-value cache 302 with respect to each different decoding layer of the transformer model as compared to these of the key and value matrices stored per the methodology described with respect to FIG. 2.

In one implementation, the self-attention block 306 is implemented within a decoding layer similar to the decoding layer 204 that is described with respect to FIG. 2. The decoding layer resides within a multi-layer transformer block which may, for example, be the same or similar to the transformer block 112 shown and described with respect to FIG. 1. The transformer model 300 is supported by a hardware architecture that allocates a fixed total quantity of memory, referred to herein as a “fixed budget,” to the key-value cache 302. The total fixed cache memory budget is algorithmically allocated between multiple layers of the transformer model (e.g., layer 0 through m−1 for a model with m decoding layers) per a pyramid-shaped cache allocation scheme that ensures each progressively higher layer in the transformer model is allocated a smaller quantity of cache memory than an immediately lower layer. To illustrate this, the key-value cache 302 shows memory units arranged in a pyramid shape 341, with different tiers of the memory units allocated to different decoding layers. Decoding layer 0 (closest to the input) is allocated the most memory, followed sequentially by decoding layer 1, decoding layer n (corresponding to the decoding layer 304), and decoding layer m−1.

In one implementation, allocation of the key-value cache 302 among the decoding layers is performed according to equations 1-3, above, with the cache allocation for the lowest decoding layer being defined by equation (1), the cache allocation for the highest layer (m−1) defined by equation (2), and the allocations of all interim layers between 0 and m−1 defined by equation (3).

Per the herein disclosed KV cache compression strategy, the self-attention block within each of decoding layers 0 to m−1 of the transformer model is permitted to cache a maximum number of key-value vector pairs, with the maximum number correlating with the quantity of cache memory allocated to the layer. This maximum number of key-value pairs that each decoding layer can store in the key-value cache 302 is a fixed value independently defined for each decoding layer, 0 to m−1, based on the quantity of cache memory allocated to that layer. Due to the above-described pyramid shape of the key-value cache 302, this maximum number of key-value vector pairs that each layer is permitted to cache decreases with the relative height of each decoding layer in the decoder stack. For example, decoding layer 0 is permitted to store up to 256 key-value vector pairs, decoding layer 1 is permitted to store up to 249 key-value vector pairs, decoding layer 2 is permitted to store 242 key-value vector pairs, and so on, with each increasing layer being permitted a different maximum number N of stored key-value pairs that is less than the maximum number of key-value pairs cached by the decoding layer directly below it.

Implementing KV cache compression includes two primary components-memory allocation and selective caching. Memory allocation is static and defined during model configuration, whereas selective caching entails a dynamic assessment that is repeated during the processing of each different token embedding in an input token sequence 350.

During memory allocation, the key-value cache 302 is allocated among the different decoding layers as generally described above, and a maximum number Nₘ of concurrently cacheable key-value pairs is determined, as a constant, for each decoding layer m based on the cache memory allocation of that decoding layer. For instance, Nₘ is determined for the decoding layer 304 by dividing the cache budget allocated to the decoding layer 304 by the quantity of memory used to store a single key-value pair (e.g., a key vector and a value vector). If the self-attention block 306 of the decoding layer 304 includes multiple attention heads, the maximum number Nₘ of concurrently cacheable key-value pairs for the decoding layer 304 may be further divided among the multiple heads. For example, each attention head is permitted to store

$$\approx \frac{{N}_{m}}{h}$$

of the most important key-value vectors, where h is the number of attention heads in the decoding layer m.

Each attention head dynamically and repeatedly performs selective caching operations while processing the token embeddings of the input sequence 350. This selective caching entails repeatedly identifying (during the processing of each different token embedding) a set of “important key-value vectors 340,” with “importance” being determined based on predefined criteria, which is described in detail below. The set of important key-value vector pairs 340 dynamically identified during the processing of the token embedding 326 includes a full set of the key-value vector pairs that are to be used to compute attention for the token embedding 326 and the full set that is to be retained in the key-value cache 302 for retrieval and potential use during processing of the next token embedding of the input embedding sequence 350.

Notably, the set of important key-value vector pairs 340 identified with respect to a given token embedding (e.g., the token embedding 326) typically includes fewer vector pairs than the number of tokens in the input embedding sequence 350, with the cap on this number set based on the memory allocated to the layer (e.g., the max number Nₘ for single-headed attention or

$$\approx \frac{{N}_{m}}{h}$$

for multi-headed attention, as discussed above). In some implementations, the first (lowest) layer in the transformer block may be permitted to store a number of key-value value vector pairs that equals the number of token embeddings in the input embedding sequence 350.

To identify the set of the important key-value vectors 340 in each token processing operation, the input preparer 320 implements operations-described below-to determine a set of most important token embeddings (also referred to herein as “important tokens”) in the input embedding sequence 350. These most important token embeddings are the token embeddings with the corresponding key-value vector pairs that are to be added to the set of important key-value vector pairs 340 and retained, at least temporarily, in the key-value cache 302.

In the example shown, the self-attention block 306 is shown processing the token embedding 326, which corresponds to the eighth token embedding (“eyes”) in the input embedding sequence 350 (“extreme brightness of the sun hurts the eyes”). The self-attention block 306 includes an input preparer 320 that evaluates predefined criteria to select the most important token embeddings from the already-processed portion of the input embedding sequence 350. When satisfied, this predefined criteria generally indicates a strong semantic relationship between the token and one or more other tokens in an input prompt sequence.

According to one implementation, the “most important tokens” identified for each token processing operation are defined to automatically include a fixed number, a, of instruction tokens 328. As used herein, the term “instruction tokens” refers to a subset of one or more token embeddings in the input embedding sequence 350 that immediately precede the token embedding being processed (e.g., the token embedding 326, x₇), as these immediately-preceding embeddings have been shown to contain the most immediate task-related information. In some literature, “instruction tokens” are referred to as a “local window” being processed. The fixed number of instruction tokens, a, is a hyperparameter that may vary based on implementation; however, this hyperparameter is constant for every decoding layer within the transformer block.

In the example of FIG. 3, the hyperparameter a is set to “2.” Therefore, when the self-attention block 306 is processing the eighth embedding (x₇) in the input embedding sequence 350, the hyperparameter α=2 is used to identify the set of instruction tokens 328, which in this case includes the previously-processed token embeddings x₅ and x₆, that respectively correspond to the tokens “hurts” and “the.”

The instruction tokens 328 are automatically selected for inclusion in the set of “most important tokens.” Consequently, a key-value vector pair corresponding to each of the instruction tokens 328 is added to the set of important key-value vector pairs 340 that is to be used in the attention computation for the token embedding 326. Following this, the input preparer 320 computes localized attention scores to identify an additional number of important tokens “r” to be added to the set of most important tokens, where r depends upon the quantity of memory from the key-value cache 302 that has been allocated to the decoding layer 304. For example, in an implementation where the self-attention block 306 includes a single head, the additional number of important tokens r is a whole number between 0 and Nₘ−α, where Nₘ is the maximum number of important key-vector pairs that the entire decoding layer m is permitted to store. In an implementation where the self-attention block 306 includes multiple heads, the additional number of important tokens r selected by each attention head (e.g., in addition to the instruction tokens 328) is given by some subset of the total maximum number of the important key-vector pairs that the decoding layer is permitted to store in the key-value

$$\approx \frac{{N}_{m} - α}{h} ,$$

cache, such as where h is the number of attention heads.

To select the additional important tokens (e.g., with key-value vectors to be included in the important key-value vector pairs 340), a localized attention score 330 is computed for each token embedding represented in the input embedding sequence 350. The localized attention score 330 measures the level of attention that a token embedding receives from its instruction tokens. In the illustrated example, the localized attention score 330 is computed for the token embedding 326, x₇, corresponding to the word “eyes.” In this case, the localized attention score 330 depends exclusively upon the token embedding 326 and the key and value vectors for the instruction tokens 328. In a multi-headed attention block where attention weights are traditionally computed using equation (4) above (which defines a set of attention scores for each head, A^{h}), the localized attention score for each token embedding in the input embedding sequence 350 of index “i” can be computed by equation (5) below:

$${s}_{i}^{h} = {\sum }_{j ∈ [ n - α , n ]} {A}_{ij}^{h} \qquad ( 5 )$$

where [n−α, n] is the range of instruction tokens immediately preceding the token at index i. Using this localized attention score 330 that is computed for each token embedding in the input embedding sequence 350, the input preparer 320 derives a set of localized attention scores 332 (e.g., one for each token in the input embedding sequence 350) and then identifies the additional “r” number of these embeddings that have the highest localized attention scores, with the instruction tokens 328 excluded from this selection and where r is, as defined above, the maximum number of key-value vector pairs that can be stored by the attention head in addition to the key-value vector pairs for the instruction tokens 328.

The localized attention scores 332 can be computed for each token embedding with very low processing overhead as compared to the traditional attention mechanism, which depends upon the key and value vectors of all previously-processed token embeddings.

Notably, it may not be necessary to re-compute all the localized attention scores 332 during the processing of each new token embedding of the input embedding sequence 350. Instead, the input preparer 320 can store (e.g., in the key-value cache 302 or other memory) an array that includes the token index, i, and the localized attention score for the top r additional tokens selected as the “most important tokens” based on their respective localized attention scores during the previous embedding processing operation. If the localized attention score for any of the instruction tokens 328 or the token embedding 326 of the current processing operation exceeds the localized attention score for a select one of the “r” previously-identified most important tokens, the token index and score of the newly-processed token with the higher localized attention score is stored in the array and the previously-stored token information with the lower localized attention score is dropped from the array. For example, if each attention head in the decoding layer 304 is permitted to retain 200 key-value vector pairs, including the key-value vector pairs for ten instruction tokens, the input preparer 320 may store an array that includes the localized attention score and token index for the 190 tokens with the highest localized attention scores. Each time a newly-scored token has a localized attention score that is higher than a previously-scored token identified in the array, the information for the previously-processed token is dropped from the array in favor of the index and localized attention score for the newly-processed token. The tokens identified in this array, together with the instruction tokens, are identified as the “most important tokens” for the current embedding processing operations.

During the processing of each new token embedding, the important key-value pairs 340 are defined to include the key vector and value vector of each token embedding in the newly identified set of most important tokens. These important key-value vector pairs are used to compute attention for the token embedding being processed (e.g., the token embedding 326) and are also retained in the key-value cache 302 until at least the next token decoding operation for the input embedding sequence 350. Each time the important key-value vector pairs 340 are dynamically identified, all other key-vector values previously cached by the same attention head in the self-attention block 306 are discarded from the key-value cache 302 and omitted from the key and value matrices used in subsequent attention computations of the self-attention block 306 for the input embedding sequence 350.

In the simplified illustrated example shown in FIG. 3, the self-attention block 306 includes a single attention head that is permitted to cache up to a maximum of five key-value vector pairs in the key-value cache 302, including the key-value vectors for the two instruction tokens 328 and three additional tokens selected for having the highest localized attention scores (e.g., ∝=2 and r=3). When processing the token embedding 326 (x₇), the input preparer 320 selectively caches the key vector and value vector corresponding to each of the instruction tokens 328 (x₅ and x₆) and also caches the key and value vectors corresponding to the three additional tokens (e.g., x₁, x₄, and x₇) that are determined to have the highest localized attention scores (with the instruction tokens 328 being excluded from this score-based selection). Consequently, the important key-value vector pairs 340 include the key and value vectors for tokens x₁, x₄, x₅, x₆, and x₇. These important key-value vector pairs 340 are stored in the key-value cache 302 as “cached key-value vectors 352,” which are depicted in matrix form in FIG. 3 to indicate that this set of vectors exclusively forms the K and V matrices used to compute attention for the token embedding 326. The cached key-value vectors 352 are provided as input to the attention compute logic 333, along with a query vector Q that is computed for the token embedding 326. Using this information, the attention compute logic 333 computes the attention for the token embedding 326 as generally described with respect to the self-attention block 206 of FIG. 2.

FIG. 4 illustrates an example plot 400 that illustrates selective caching of various key-value vector pairs according to the herein-disclosed KV cache compression methodology. The X-axis of the plot 400 corresponds to the indices of token embeddings in an input embedding sequence. The y-axis of the plot 400 corresponds to decoding layer index in a decoder layer stock with the bottom-most decoding layer (layer 0) receiving the input to the transformer block and the top-most decoding layer (layer 31) producing the output of the transformer block. In this plot, each square identifies a key-value pair that was retained in the key-value cache, with the decoding layer (y-axis value) denoting which decoding layer cached the key-value pair and the token index indicating the corresponding token embedding. A square with a solid outline corresponds to a key-value pair that was retained in the key-value cache at the corresponding decoding layer; in contrast, a square lacking a solid outline indicates a key-value vector pair that was not retained in the key-value cache. Shading of the square corresponds to the localized attention score computed for the key-value pair, per the methodology described with respect to FIG. 3, with increasingly darker shades of greyscale corresponding to higher and higher localized attention scores.

In this example, the number of instruction tokens is set to equal two. These instruction tokens correspond to token indices 18 and 19. At the lowest decoding layer (0), the key-value vectors of all previously processed tokens are retained in the key-value cache when processing the last token in the sequence (i=20). Here, 20 key-value vector pairs are cached. At the next lowest layer (1), 14 total key-value vector pairs are retained in the key-value cache when processing the last token in the sequence. At the next decoding lowest layer, 12 total key-value vector pairs are retained in the key-value cache when processing the last token in the sequence. This pattern continues, with each increasingly deciding layer retaining the same or a smaller number of key-value cache pairs than the layer directly below it. At the top decoding layer (31), five total key-value vector pairs are retained in the key-value cache when processing the last token in the sequence. Thus, the top decoding layer utilizes one-quarter of the cache memory allocation that is utilized by the lowest decoding layer.

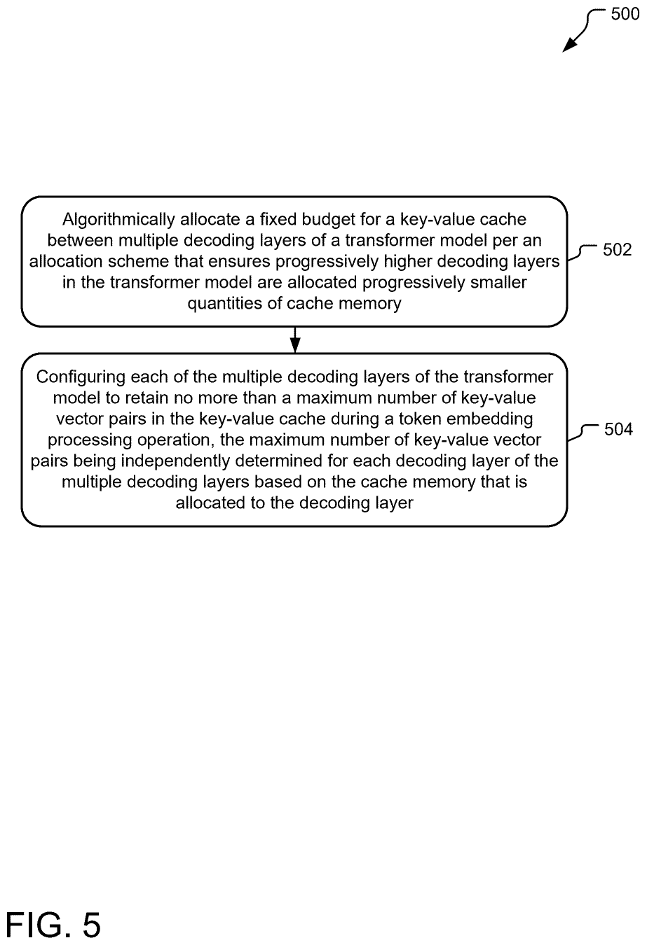

FIG. 5 illustrates example operations 500 for KV cache compression according to the herein-disclosed technology. An allocation operation 502 provides for algorithmically allocating a fixed budget for a key-value cache among multiple decoding layers of a transformer model per an allocation scheme that ensures progressively higher decoding layers in the transformer model are allocated progressively smaller quantities of cache memory. Specifically, each decoding layer in the KV cache is allocated an identical or smaller quantity of memory than the decoding layer directly below it, with the lowest decoding layer having a smaller memory allocation than the highest decoding layer. According to one implementation, this memory allocation is statically performed during the initial configuration of the transformer model and remains unchanged during ongoing nominal operations of the transformer model.

A configuration operation 504 configures each of the multiple decoding layers of the transformer model to retain no more than a predefined maximum number of key-value pairs in the key-value cache during each token processing operation. The maximum number of key-value vector pairs is independently determined for each decoding layer based on the cache memory allocated to it. Consequently, increasingly higher decoding layers in the transformer model are permitted to store fewer and fewer key-value vector pairs in the KV cache.

Although not shown in FIG. 5, the operations 500 may further comprise selective caching operations to select important key-value pairs to cache during the processing of each token embedding in an input sequence. In one implementation, a first decoding layer of the multiple decoding layers is configured to dynamically identify a set of “most important token embeddings” while processing a select token embedding of the input embedding sequence. Within the key-value cache, the decoding layer retains a key-value vector pair for each of the dynamically identified most important token embeddings. The decoding layer computes attention for the select token embedding using key and value matrices that consist exclusively of key-value vector pairs corresponding to the most important token.

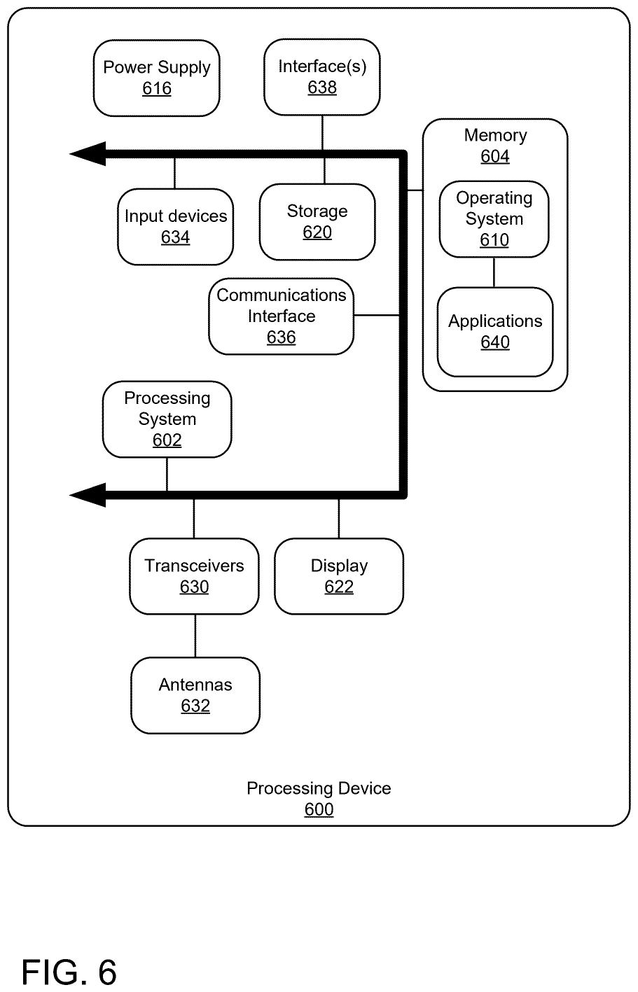

According to another implementation, dynamically identifying the subset of important tokens includes identifying a fixed number of instruction tokens that immediately precede the token embedding in the input embedding sequence, determining an additional number of cacheable key-vector pairs by subtracting the fixed number of instruction tokens from the maximum number of key-value vector pairs determined for the decoding layer; and selecting a subset of tokens with highest localized attention scores, the subset of tokens including the additional number of cacheable key-vector pairs.

[[Please note that FIG. 6 is intended to illustrate a general-purpose computer and is not specific to your invention]]. FIG. 6 illustrates an example computing device 600 for use in implementing the described technology. The computing device 600 may be a client computing device (such as a laptop computer, a desktop computer, or a tablet computer), a server/cloud computing device, an Internet-of-Things (IoT), any other type of computing device, or a combination of these options. The computing device 600 includes one or more hardware processor(s) 602 and a memory 604. The memory 604 generally includes both volatile memory (e.g., RAM) and nonvolatile memory (e.g., flash memory), although one or the other type of memory may be omitted. An operating system 610 resides in the memory 604 and is executed by the processor(s) 602. In some implementations, the computing device 600 includes and/or is communicatively coupled to storage 620.

In the example computing device 600, as shown in FIG. 6, one or more software modules, segments, and/or processors, such as applications 650, a transformer, decoding layers, linear projection layers, position embedders, spectral layers, spectral processors, self-attention blocks, attention processors, attention networks, processing modules, classifier heads, layer normalizers, multi-layer perceptrons, multi-head self-attention layers, convolutional operators, spectral gating networks, embedding processors, output interfaces, an image embedder, an image encoder, an image classifier, a nonlinear activation function, and other program code and modules are loaded into the operating system 610 on the memory 604 and/or the storage 620 and executed by the processor(s) 602. The storage 620 may store an input dataset (e.g., an input image including a set of patches), a dataset of identified features (e.g., including a classification determined for an input image), embedding spaces, weights, parameters (e.g., matrices, initial parameters sampled from Gaussian distributions, a kernel parameter, or other parameters), functions for determining parameters, and other data and be local to the computing device 600 or may be remote and communicatively connected to the computing device 600. In particular, in one implementation, components of a system for classifying a dataset may be implemented entirely in hardware or in a combination of hardware circuitry and software.

The computing device 600 includes a power supply 616, which may include or be connected to one or more batteries or other power sources and which provides power to other components of the computing device 600. The power supply 616 may also be connected to an external power source that overrides or recharges the built-in batteries or other power sources.

The computing device 600 may include one or more communication transceivers 630, which may be connected to one or more antenna(s) 632 to provide network connectivity (e.g., mobile phone network, Wi-Fi®, Bluetooth®) to one or more other servers, client devices, IoT devices, and other computing and communications devices. The computing device 600 may further include a communications interface 636 (such as a network adapter or an I/O port, which are types of communication devices). The computing device 600 may use the adapter and any other types of communication devices for establishing connections over a wide-area network (WAN) or local-area network (LAN). It should be appreciated that the network connections shown are exemplary and that other communications devices and means for establishing a communications link between the computing device 600 and other devices may be used.

The computing device 600 may include one or more input devices 634 such that a user may enter commands and information (e.g., a keyboard, trackpad, or mouse). These and other input devices may be coupled to the server by one or more interfaces 638, such as a serial port interface, parallel port, or universal serial bus (USB). The computing device 600 may further include a display 622, such as a touchscreen display.

The computing device 600 may include a variety of tangible processor-readable storage media and intangible processor-readable communication signals. Tangible processor-readable storage can be embodied by any available media that can be accessed by the computing device 600 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes but is not limited to RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 600. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

In some aspects, the techniques described herein relate to a method including: algorithmically allocating a fixed budget for a key-value cache between multiple decoding layers of a transformer model per an allocation scheme that ensures progressively higher decoding layers in the transformer model are allocated progressively smaller quantities of cache memory; and configuring each of the multiple decoding layers of the transformer model to retain no more than a maximum number of key-value vector pairs in the key-value cache during a token decoding operation, the maximum number of key-value vector pairs being independently determined for each decoding layer of the multiple decoding layers based on the cache memory that is allocated to the decoding layer.

In some aspects, the techniques described herein relate to a method, wherein algorithmically allocating the fixed budget for the cache memory results in a layer-specific memory allocation that remains fixed throughout nominal operations of the transformer model.

In some aspects, the techniques described herein relate to a method, wherein the maximum number of key-value vector pairs determined for each decoding layer of the multiple decoding layers is identical or smaller than the maximum number of key-value vector pairs determined for an immediately preceding decoding layer.

In some aspects, the techniques described herein relate to a method, further including: within a first decoding layer of the multiple decoding layers and during processing of a token embedding of an input embedding sequence: dynamically identifying a subset of important tokens within the input embedding sequence; and retaining, in the key-value cache, a key-value vector pair for each token in the subset of important tokens; and computing attention for the token embedding within the first decoding layer using key and value matrices that consists of vectors included in the subset of important tokens.

In some aspects, the techniques described herein relate to a method, wherein dynamically identifying the subset of important tokens includes: selecting for inclusion in the subset of important tokens a fixed number of instruction tokens that immediately precede the token embedding in the input embedding sequence; and using localized attention scores to select an additional subset of tokens preceding the token embedding in the input embedding sequence for inclusion in the subset of important tokens.

In some aspects, the techniques described herein relate to a method, further including: computing a localized attention score for each embedding in the input embedding sequence that has been previously-processed by the first decoding layer, wherein selecting the additional subset of tokens to include in the subset of important tokens includes selecting tokens corresponding to embeddings with highest values for the localized attention scores.

In some aspects, the techniques described herein relate to a method, wherein selecting the additional subset of tokens to include in the subset of important tokens further includes: subtracting a fixed number of instruction tokens from the maximum number of key-value vector pairs determined for the decoding layer to identify an additional number of important tokens; and selecting a subset of tokens with highest localized attention scores, the subset of tokens including the additional number of important tokens.

In some aspects, the techniques described herein relate to a method, wherein the fixed number of the instruction tokens is a hyperparameter of the transformer model and constant across all decoding layers of the transformer model.

In some aspects, the techniques described herein relate to a system including: a transformer model including multiple decoding layers, each of the multiple decoding layers being allocated a fixed budget for a key-value cache according to an allocation scheme that ensures progressively higher decoding layers in the transformer model are allocated progressively smaller quantities of cache memory; and a first decoding layer included in the multiple decoding layers that includes a self-attention block that retains up to a first predefined maximum number of key-value vector pairs in the key-value cache during processing of a token embedding of an input embedding sequence, the first predefined maximum number of key-value vector pairs being determined for the first decoding layer based on the cache memory allocated to the first decoding layer.

In some aspects, the techniques described herein relate to a system, wherein the allocation scheme provides for a fixed allocation to the cache memory among the multiple decoding layers throughout nominal operations of the transformer model.

In some aspects, the techniques described herein relate to a system, further including: a second decoding layer that provides an output to the first decoding layer, the second decoding layer including another self-attention block that retains up to a second predefined maximum number of key-value vector pairs in the key-value cache during the processing of the token embedding, the second predefined maximum number of key-value vector pairs being greater than the first predefined maximum number of key-value vector pairs.

In some aspects, the techniques described herein relate to a system, wherein the self-attention block of the first decoding layer is configured to: dynamically identify a subset of important tokens within the input embedding sequence during the processing of the token embedding; retain, in the key-value cache, a key-value vector pair for each embedding corresponding to a token in the subset of important tokens.

In some aspects, the techniques described herein relate to a system, wherein the self-attention block of the first decoding layer is further configured to: compute attention for the token embedding of the input embedding sequence using key and value matrices that consists of vectors included in the subset of important tokens.

In some aspects, the techniques described herein relate to a system, wherein the first decoding layer dynamically identifies the subset of important tokens by performing operations that include: selecting for inclusion in the subset of important tokens a fixed number of instruction tokens that immediately precede the token embedding in the input embedding sequence; and using localized attention scores to select an additional subset of tokens preceding the token embedding in the input embedding sequence for inclusion in the subset of important tokens.

In some aspects, the techniques described herein relate to a system, wherein the first decoding layer computes a localized attention score for each embedding in the input embedding sequence that has been previously-processed, and wherein the additional subset of tokens includes tokens corresponding to embeddings with highest values of the localized attention score.

In some aspects, the techniques described herein relate to a system, wherein the fixed number of instruction tokens is a hyperparameter of the transformer model and constant across each of the multiple decoding layers of the transformer model.

In some aspects, the techniques described herein relate to one or more tangible processor-readable storage media encoding processor-executable instruction for executing a computer process, the computer process including: processing a token embedding of an input embedding sequence within a first decoding layer of a transformer model, the first decoding layer being among multiple decoding layers within the transformer model statically allocated a portion of a total fixed budget for a key-value cache according to an allocation scheme that ensures progressively higher decoding layers in the transformer model are allocated progressively smaller quantities of cache memory; and within a first self-attention block of the first decoding layer, retaining up to a first predefined maximum number of key-value vector pairs in the key-value cache during processing of the token embedding of the input embedding sequence, the first predefined maximum number of key-value vector pairs being determined for the first decoding layer based on the cache memory allocated to the first decoding layer.

In some aspects, the techniques described herein relate to one or more tangible processor-readable storage media, wherein the computer process further includes: within a second self-attention block of a second decoding layer that provides an output to the first decoding layer, retaining up to a second predefined maximum number of key-value vector pairs in the key-value cache during the processing of the token embedding, the second predefined maximum number of key-value vector pairs being greater than the first predefined maximum number of key-value vector pairs.

In some aspects, the techniques described herein relate to one or more tangible processor-readable storage media, wherein the computer process further includes: within the first self-attention block and during processing of the token embedding: dynamically identifying a subset of important tokens from the input embedding sequence and retaining, in the key-value cache, a key-value vector pair for each embedding corresponding to a token in the subset of important tokens; and computing attention for the token embedding using key and value matrices that consists of vectors included in the subset of important tokens.

In some aspects, the techniques described herein relate to one or more tangible processor-readable storage media, wherein dynamically identifying a subset of important tokens further includes: selecting for inclusion in the subset of important tokens a fixed number of instruction tokens that immediately precede the token embedding in the input embedding sequence; and using localized attention scores to select an additional subset of tokens preceding the token embedding in the input embedding sequence for inclusion in the subset of important tokens. The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, depending on the computer system's performance requirements. Accordingly, the logical operations making up the implementations described herein are referred to variously as operations, steps, objects, or modules. Furthermore, it should be understood that logical operations may be performed in any order unless explicitly claimed otherwise or a specific order is inherently necessitated by the claim language. The above specification, examples, and data, together with the attached appendices, provide a complete description of the structure and use of exemplary implementations.

What is claimed is:

1. A method comprising:
algorithmically allocating a fixed budget for a key-value cache between multiple decoding layers of a transformer model per an allocation scheme that ensures progressively higher decoding layers in the transformer model are allocated progressively smaller quantities of cache memory; and
configuring each of the multiple decoding layers of the transformer model to retain no more than a maximum number of key-value vector pairs in the key-value cache during a token decoding operation, the maximum number of key-value vector pairs being independently determined for each decoding layer of the multiple decoding layers based on the cache memory that is allocated to the decoding layer.

2. The method of claim 1, wherein algorithmically allocating the fixed budget for the cache memory results in a layer-specific memory allocation that remains fixed throughout nominal operations of the transformer model.

3. The method of claim 1, wherein the maximum number of key-value vector pairs determined for each decoding layer of the multiple decoding layers is identical or smaller than the maximum number of key-value vector pairs determined for an immediately preceding decoding layer.

4. The method of claim 1, further comprising:
within a first decoding layer of the multiple decoding layers and during processing of a token embedding of an input embedding sequence:
dynamically identifying a subset of important tokens within the input embedding sequence; and
retaining, in the key-value cache, a key-value vector pair for each token in the subset of important tokens; and
computing attention for the token embedding within the first decoding layer using key and value matrices that consists of vectors included in the subset of important tokens.

5. The method of claim 4, wherein dynamically identifying the subset of important tokens includes:
selecting for inclusion in the subset of important tokens a fixed number of instruction tokens that immediately precede the token embedding in the input embedding sequence; and
using localized attention scores to select an additional subset of tokens preceding the token embedding in the input embedding sequence for inclusion in the subset of important tokens.

6. The method of claim 5, further comprising:
computing a localized attention score for each embedding in the input embedding sequence that has been previously-processed by the first decoding layer, wherein selecting the additional subset of tokens to include in the subset of important tokens includes selecting tokens corresponding to embeddings with highest values for the localized attention scores.

7. The method of claim 6, wherein selecting the additional subset of tokens to include in the subset of important tokens further comprises:
subtracting a fixed number of instruction tokens from the maximum number of key-value vector pairs determined for the decoding layer to identify an additional number of important tokens; and
selecting a subset of tokens with highest localized attention scores, the subset of tokens including the additional number of important tokens.

8. The method of claim 5, wherein the fixed number of the instruction tokens is a hyperparameter of the transformer model and constant across all decoding layers of the transformer model.

9. A system comprising:
a transformer model including multiple decoding layers, each of the multiple decoding layers being allocated a fixed budget for a key-value cache according to an allocation scheme that ensures progressively higher decoding layers in the transformer model are allocated progressively smaller quantities of cache memory; and
a first decoding layer included in the multiple decoding layers that includes a self-attention block that retains up to a first predefined maximum number of key-value vector pairs in the key-value cache during processing of a token embedding of an input embedding sequence, the first predefined maximum number of key-value vector pairs being determined for the first decoding layer based on the cache memory allocated to the first decoding layer.

10. The system of claim 9, wherein the allocation scheme provides for a fixed allocation to the cache memory among the multiple decoding layers throughout nominal operations of the transformer model.

11. The system of claim 9, further comprising:
a second decoding layer that provides an output to the first decoding layer, the second decoding layer including another self-attention block that retains up to a second predefined maximum number of key-value vector pairs in the key-value cache during the processing of the token embedding, the second predefined maximum number of key-value vector pairs being greater than the first predefined maximum number of key-value vector pairs.

12. The system of claim 9, wherein the self-attention block of the first decoding layer is configured to:
dynamically identify a subset of important tokens within the input embedding sequence during the processing of the token embedding;
retain, in the key-value cache, a key-value vector pair for each embedding corresponding to a token in the subset of important tokens.

13. The system of claim 12, wherein the self-attention block of the first decoding layer is further configured to:
compute attention for the token embedding of the input embedding sequence using key and value matrices that consists of vectors included in the subset of important tokens.

14. The system of claim 12, wherein the first decoding layer dynamically identifies the subset of important tokens by performing operations that include:
selecting for inclusion in the subset of important tokens a fixed number of instruction tokens that immediately precede the token embedding in the input embedding sequence; and
using localized attention scores to select an additional subset of tokens preceding the token embedding in the input embedding sequence for inclusion in the subset of important tokens.

15. The system of claim 14, wherein the first decoding layer computes a localized attention score for each embedding in the input embedding sequence that has been previously-processed, and wherein the additional subset of tokens includes tokens corresponding to embeddings with highest values of the localized attention score.

16. The system of claim 14, wherein the fixed number of instruction tokens is a hyperparameter of the transformer model and constant across each of the multiple decoding layers of the transformer model.

17. One or more tangible processor-readable storage media encoding processor-executable instruction for executing a computer process, the computer process comprising:
processing a token embedding of an input embedding sequence within a first decoding layer of a transformer model, the first decoding layer being among multiple decoding layers within the transformer model statically allocated a portion of a total fixed budget for a key-value cache according to an allocation scheme that ensures progressively higher decoding layers in the transformer model are allocated progressively smaller quantities of cache memory; and
within a first self-attention block of the first decoding layer, retaining up to a first predefined maximum number of key-value vector pairs in the key-value cache during processing of the token embedding of the input embedding sequence, the first predefined maximum number of key-value vector pairs being determined for the first decoding layer based on the cache memory allocated to the first decoding layer.

18. The one or more tangible processor-readable storage media of claim 17, wherein the computer process further comprises:
within a second self-attention block of a second decoding layer that provides an output to the first decoding layer, retaining up to a second predefined maximum number of key-value vector pairs in the key-value cache during the processing of the token embedding, the second predefined maximum number of key-value vector pairs being greater than the first predefined maximum number of key-value vector pairs.

19. The one or more tangible processor-readable storage media of claim 17, wherein the computer process further comprises:
within the first self-attention block and during processing of the token embedding:
dynamically identifying a subset of important tokens from the input embedding sequence and retaining, in the key-value cache, a key-value vector pair for each embedding corresponding to a token in the subset of important tokens; and
computing attention for the token embedding using key and value matrices that consists of vectors included in the subset of important tokens.

20. The one or more tangible processor-readable storage media of claim 19, wherein dynamically identifying a subset of important tokens further comprises:
selecting for inclusion in the subset of important tokens a fixed number of instruction tokens that immediately precede the token embedding in the input embedding sequence; and
using localized attention scores to select an additional subset of tokens preceding the token embedding in the input embedding sequence for inclusion in the subset of important tokens.
